(19) United States
(12) Patent Application Publication
(10) Pub. No.: US 2008/0024680 A1
(43) Pub. Date: Jan. 31, 2008

(54) Digital broadcast receiving apparatus and digital broadcast receiving method

(75) Inventor: Masatoshi Takegoshi, Sakado-shi (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 11/826,151

(22) Filed: Jul. 12, 2007

(30) Foreign Application Priority Data
Jul. 31, 2006 (JP) 2006-208470

(51) Int. Cl. H04N 5/50

(52) U.S. Cl. 348/731

(57) ABSTRACT

According to one embodiment, a digital broadcast receiving apparatus includes a plurality of tuners selecting broadcast waves of digital broadcasting to receive frequencies in the same band. The digital broadcast receiving apparatus further includes a control unit which performs control in which, when a first channel currently viewed with the use of a first tuner out of the plural tuners is changed to a second channel to be viewed with the use of a second tuner out of the plural tuners and subsequently a channel operation takes place for changing the second channel to the first channel, the first tuner having tuned to the first channel is used for viewing a program of the first channel.

### CROSS-REFERENCE TO RELATED APPLICATIONS

This application is based upon and claims the benefit of priority from Japanese Patent Application No. 2006-208470, filed Jul. 31, 2006, the entire contents of which are incorporated herein by reference.

### BACKGROUND

1. Field

One embodiment of the invention relates to a digital broadcast receiving apparatus including a plurality of tuners receiving digital terrestrial broadcasting waves, digital satellite broadcasting waves, and the like, and to a digital broadcast receiving method.

2. Description of the Related Art

In recent years, digital broadcast receiving apparatuses have been widely used which receive digital terrestrial broadcasting waves and digital satellite broadcasting waves such as BS (Broadcasting Satellite) waves and 110-degree CS (Communication Satellite) waves to reproduce digitized video signals and sound signals.

Various digital broadcast receiving apparatuses have been conventionally known, and for example, Japanese Patent Publication (KOKAI) No. 3007068 (patent document 1) discloses a digital broadcast receiving apparatus which shortens the time required for a program of a destination channel of channel change to become viewable (hereinafter, referred to as “the required time for viewing”).

In this digital broadcast receiving apparatus, a main tuner tunes to a channel to be viewed, and next, a sub-tuner tunes in advance to a channel expected to be selected next. Then, when a channel designated by a channel operation matches the channel which has been tuned to, the sub-tuner is used in place of the main tuner, and a broadcast of the channel which has been tuned to by the sub-tuner is viewed.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram showing the configuration of a digital broadcast receiving apparatus according to an embodiment of the invention;

FIG. 2 is an exemplary flowchart showing the operation procedure for tuning processing according to a first embodiment;

FIGS. 3(a) to 3(c) are exemplary views showing an example of operations of two tuners in the embodiment when channels are alternately changed;

FIG. 4 is an exemplary flowchart showing the operation procedure for tuning processing according to a second embodiment; and

FIG. 5 is an exemplary flowchart showing the operation procedure for tuning processing according to a third embodiment.

### DETAILED DESCRIPTION

Various embodiments according to the invention will be described hereinafter with reference to the accompanying drawings. In general, according to one embodiment of the invention, a digital broadcast receiving apparatus includes a plurality of tuners selecting broadcast waves of digital broadcasting to receive frequencies in a same band. The digital broadcast receiving apparatus further includes a control unit which performs control in which, when a first channel currently viewed with the use of a first tuner out of the plural tuners is changed to a second channel to be viewed with the use of a second tuner out of the plural tuners and subsequently a channel operation takes place for changing the second channel to the first channel, the first tuner having tuned to the first channel is used for viewing a program of the first channel.

Further, a digital broadcast receiving method includes performing control in which, when a first channel currently viewed is changed to a second channel to be viewed and subsequently a channel operation takes place for changing the second channel back to the first channel, a tuner having originally tuned to the first channel, out of a plurality of tuners, is used for viewing a program of the first channel.

### First Embodiment

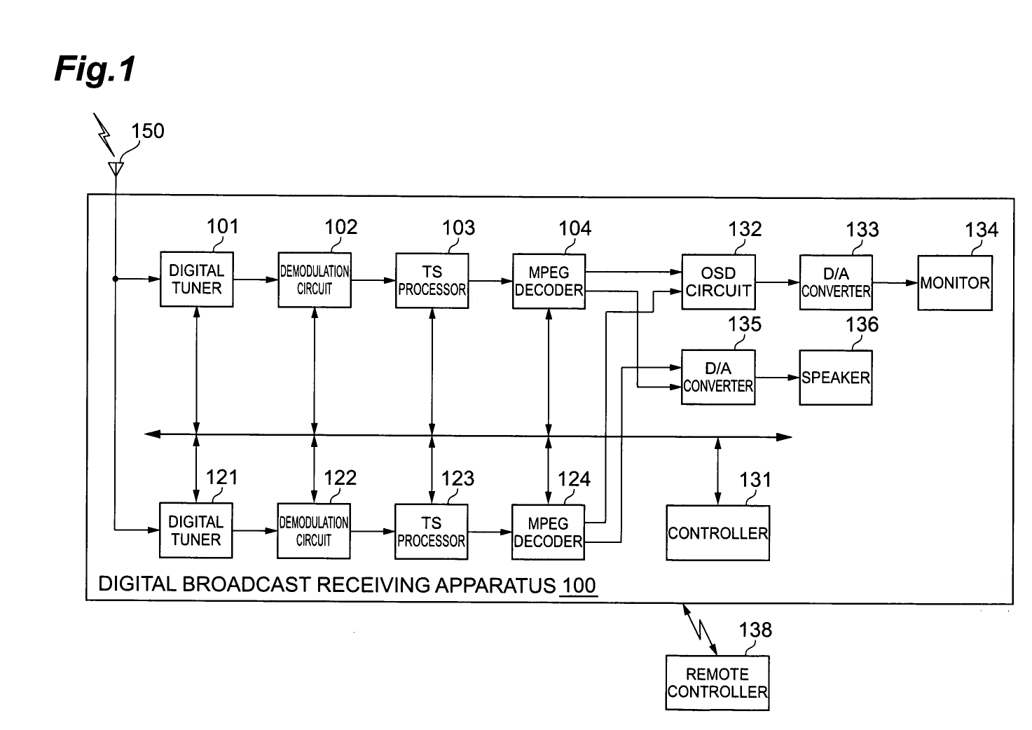

FIG. 1 is an exemplary block diagram showing the configuration of a digital broadcast receiving apparatus 100 according to an embodiment of the invention. As shown in FIG. 1, the digital broadcast receiving apparatus 100 has two digital tuners 101, 121 having the same function, and besides, has demodulation circuits 102, 122, TS processors 103, 123, and MPEG decoders 104, 124.

The digital broadcast receiving apparatus 1 further has a controller 131, an OSD circuit 132, D/A converters 133, 135, a monitor 134, and a speaker 136.

The digital tuners 101, 121 are both supplied with broadcast waves received by an antenna 150 for digital terrestrial broadcasting. The digital tuners 101, 121 perform reception processing for selecting and receiving signal components each with a predetermined frequency corresponding to a designated channel from the broadcast waves supplied from the antenna 150, and output the signal components to the demodulation circuits 102, 122 respectively.

The demodulation circuits 102, 122 demodulate the signal components extracted by the digital tuners 101, 121 respectively, in a predetermined manner and further process error correction and so on to generate transport streams (TS1, TS2) respectively. The generated transport streams TS1, TS2 are inputted to the TS processors 103, 123 respectively.

The TS processors 103, 123 discern packet IDs (PID) appended to TS packets of the inputted transport streams TS1, TS2 to extract ESs (Elementary Streams) such as sections as channel selection information, videos, and sounds.

Each of the TS processors 103, 123 acquires a PAT (Program Association Table) and PMTs (Program Map Tables) (to be described later) to recognize a packet ID of video, sound, and so on to be received and they output, to the MPEG decoders 104, 124, TS packets whose packet IDs match the recognized packet ID.

The TS processors 103, 123 also separate SI (Service Information) data from the inputted TS packets and supply the SI data to the microprocessor 131.

Here, the PAT has data on packet IDs of TS packets carrying the PMTs associated with broadcast programs.

Further, the PMT has data on a packet ID of a TS packet carrying coded signals (video signals, sound signals, and so on) making up the broadcast program and packet ID of a TS packet carrying a common data (for example, ECM: Entitlement Control Message; data on a program, a descrambling key, and so on) among a related data on a pay program.

The MPEG decoders 104, 124 both process the decoding of the inputted TS packets to reproduce digital video signals and digital sound signals. Out of these, the digital video signals are inputted to the OSD circuit 132 and the digital sound signals are inputted to the D/A converter 135.

The OSD circuit 132 superimposes an OSD (On Screen Display) signal on each of the inputted digital video signals to output the resultant to the D/A converter 133. The OSD signal is generated by the controller 131 based on the SI data outputted from each of the TS processors 103, 123.

The controller 131 has a MPU (Micro Processing Unit), a ROM, and a RAM, which are not shown. In the ROM, a control program and programs executed by the MPU are written. In the RAM, a work area necessary for the execution of the programs by the MPU can be provided.

The controller 131 controls the above-described modules according to the control program stored in the ROM to centrally control video display, sound output, and so on. Further, the controller 131 receives, via an infrared receptor (not shown), operation data of a remote controller (also called a remote) 138 operated by a user and controls the operation according to the received data.

The D/A converters 133, 135 convert the inputted digital video signals and digital sound signals to analog video signals and analog sound signals respectively to output these signals. The monitor 134 is a display panel displaying video showing the contents of a currently viewed program based on the analog video signal. The speaker 136 outputs sound based on the analog sound signal.

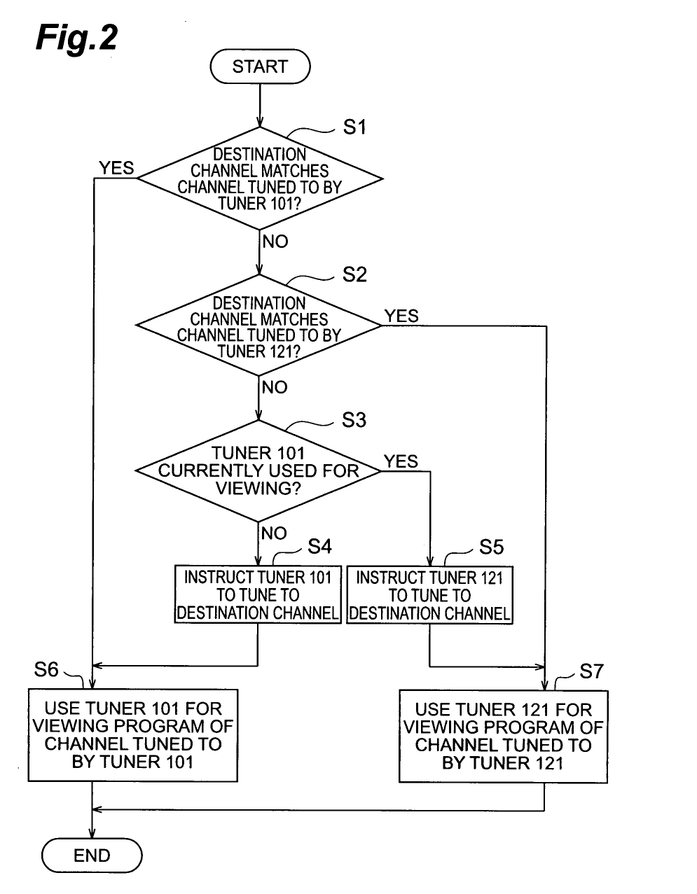

Next, the contents of the operation of tuning processing executed in the digital broadcast receiving apparatus 100 as configured above in response to a channel selection instruction by a user will be described with reference to the flowchart shown in FIG. 2.

The digital broadcast receiving apparatus 100 receives digital terrestrial broadcasting waves by the digital tuners 101, 121 and enables a program of the digital terrestrial broadcasting to be viewed. The digital terrestrial broadcasting includes VHF channels from 1 channel to 12 channel (1CH to 12CH), UHF channels from 13 channel to 62 channel (13CH to 62CH), and cable television channels from 13 channel to 63 channel (13CH to 63CH).

One of these channels is designated when a user gives a channel selection instruction by a predetermined operation such as a channel operation using the remote 138 (hereinafter, referred to as a “remote operation”). The channel designated by the channel selection instruction (for example, 25CH to be described later) is a destination channel.

In some case, the digital turners 101, 121 have already received digital terrestrial broadcasting waves and tuned to some channels in response to previous channel selection instructions. The channels already tuned to by the digital tuners 101, 121 are currently tuned channels.

FIG. 2 is an exemplary flowchart showing the operation procedure for the tuning processing executed in the digital broadcast receiving apparatus 100 in response to a channel selection instruction. The controller 131 executes the tuning processing by operating as a control unit and a tuning control unit.

When starting the tuning processing, the controller 131 proceeds to block 1, where it compares a channel designated by the channel selection instruction (destination channel) and a channel already tuned to by the digital tuner 101 (currently tuned channel) to determine whether or not the both match each other.

The controller 131 proceeds to block 6 when determining that the both match each other, while proceeding to block 2 when determining that the both do not match each other.

At block 2, the controller 131 compares the destination channel and a currently tuned channel by the digital tuner 121 to determine whether or not the both match each other.

The controller 131 proceeds to block 7 when determining that the both match each other, while proceeding to block 3 when determining that the both do not match each other.

At block 3, the controller 131 determines whether or not the currently tuned channel by the digital tuner 101 is currently viewed, that is, video of a program on air on the currently tuned channel is displayed on the monitor 134. The controller 131 proceeds to block 5 when the currently tuned channel by the digital tuner 101 is currently viewed, and otherwise, proceeds to block 4.

At block 4, the controller 131 instructs the digital tuner 101 to tune to the destination channel, and thereafter proceeds to block 6. Consequently, the digital tuner 101 tunes to the destination channel in response to the instruction of the controller 131.

Meanwhile, at block 5, the controller 131 instructs the digital tuner 121 to tune to the destination channel, and thereafter proceeds to block 7. Consequently, the digital tuner 121 tunes to the destination channel in response to the instruction of the controller 131.

At block 6, the controller 131 performs control so as to make a program of the channel tuned to by the digital tuner 101 viewable. Accordingly, the monitor 134 displays video and the speaker 136 outputs sound, based on a digital video signal and a digital sound signal which are obtained as a result of the operation of the demodulation circuit 102, the TS processor 103, and the MPEG decoder 104. In this manner, a user can view the program of the currently tuned channel by the digital tuner 101.

Meanwhile, at block 7, the controller 131 performs control so as to make the program of the currently tuned channel by the digital tuner 121 viewable. Accordingly, the monitor 134 displays video and the speaker 136 outputs sound based on a digital video signal and a digital sound signal which are obtained as a result of the operation of the demodulation circuit 122, the TS processor 123, and the MPEG decoder 124. In this manner, a user can view the program of the currently tuned channel by the digital tuner 121. After block 6 or 7 is thus executed, the tuning processing is ended.

The digital broadcast receiving apparatus 100 performs the tuning processing in the above-described manner, so that, when a destination channel does not match any of currently tuned channels by the digital tuners 101, 121, a tuner used for viewing when the channel selection instruction is given, that is, a tuner having been used for viewing up to an instant immediately preceding the channel selection instruction (tuner for last viewing) is not used but the other tuner (tuner not for last viewing) is used to tune to the destination channel.

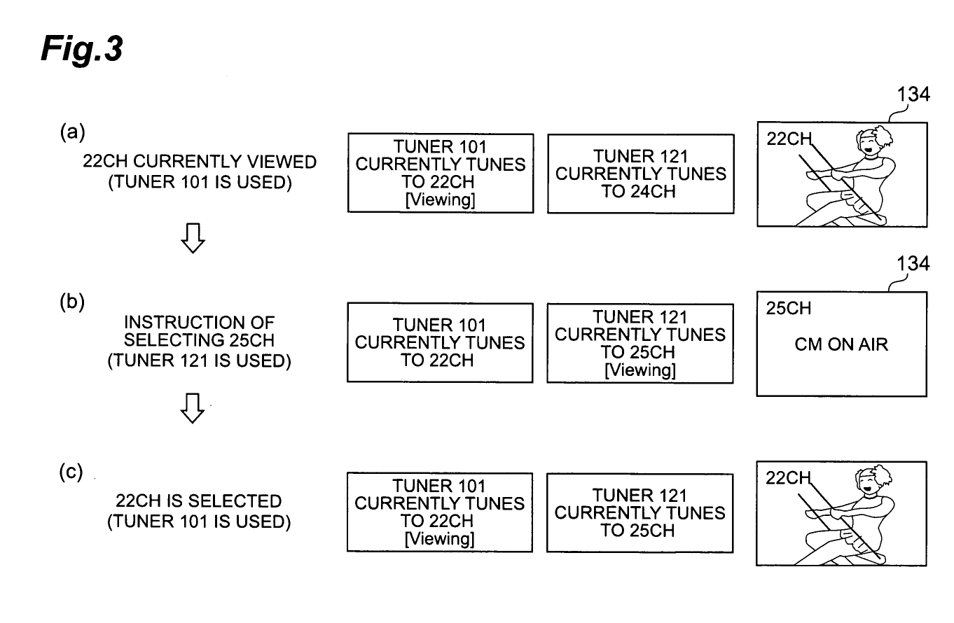

In the above-described manner, in a case where a user alternately views two channels, the digital broadcast receiving apparatus 100 can shorten the required time for viewing to allow the user to quickly view a desired program. Here, when the user is viewing two channels alternately, the user changes a first channel, which he/she has been viewing, to a second channel, and thereafter performs a channel operation for changing the second channel back to the original first channel. This issue will be described in detail with reference to FIG. 3.

For example, suppose that a user is viewing 22 channel (first channel) as shown in FIG. 3(a). In this case, suppose that the digital tuner 101 (first tuner) is tuning to 22 channel and the other digital tuner 121 (second tuner) is tuning to 24 channel. Further, since 22 channel is currently viewed, the monitor 134 displays a character string “22CH” and video showing the contents of a program currently viewed.

In this state, suppose that the user gives a channel selection instruction by a remote operation to designate 25 channel (second channel). Then, the controller 131 executes the tuning processing in the above-described manner.

In this case, since the channel selection instruction is to select 25 channel, a destination channel is 25 channel. However, since currently tuned channels by the digital tuners 101, 121 are 22 channel and 24 channel respectively, the destination channel matches neither of the two currently tuned channels, and therefore, the controller 131 proceeds to block 3.

At this time, the digital tuner 101 is a tuner for last viewing which is used for viewing when the channel selection instruction is given, and therefore the controller 131 proceeds to block 5. Therefore, the digital broadcast receiving apparatus 100 leaves the digital tuner 101 for last viewing as it is, and causes the other tuner 121 (tuner not for last viewing) to tune to 25 channel. Thereafter, block 7 is executed and a program of 25 channel is viewed.

In this case, since the digital tuner 121 tunes to the destination channel at block 5, the required time for viewing which is the time taken for the monitor 134 to display the program of the destination channel (25 channel) as shown in FIG. 3(b) is not shortened.

However, when giving a channel selection instruction by a channel operation using the remote 138, a user sometimes changes a channel by a channel selection instruction and thereafter gives a channel selection instruction again for changing the channel back to the original channel. An example of such a case is a case where a user once changes a channel in an attempt to view another program since a program he/she is currently viewing finishes, but since television CM is on air on the newly selected channel, the user changes the channel back to the original channel.

As such, the user sometimes changes channels by alternately selecting two channels while viewing broadcast programs.

Suppose the user once changes a channel for viewing from 22 channel to 25 channel, but television CM is on air on 25 channel as shown in FIG. 3(b). Therefore, suppose that the user thereafter performs a channel operation again for changing a channel for viewing to 22 channel (that is, a channel operation for changing 25 channel to 22 channel).

Then, since the destination channel corresponding to the channel selection instruction in this case is 22 channel, the destination channel and the currently tuned channel match each other. Therefore, when executing the tuning processing shown in FIG. 2 again, the controller 131 proceeds from block 1 to block 6, where the control is performed so as to make the program of 22 channel currently tuned to by the digital tuner 101 viewable.

In this case, since the digital broadcast receiving apparatus 100 executes block 6 without executing block 4, the demodulation circuit 102, the TS processor 103, and the MPEG decoder 104 operate and the program of 22 channel is viewed without the digital tuner 101 newly tuning to the destination channel. This can shorten the required time for viewing since the program of the destination channel can be viewed without the digital tuner 101 newly tuning to the destination channel.

Therefore, as shown in FIG. 3(c), a character string “22CH” and the program on air on 22 channel are quickly displayed.

In this manner, in the digital broadcast receiving apparatus 100, when a destination channel does not match any of currently tuned channels, the tuner for last viewing is left as it is and a tuner not for last viewing is used to tune to the destination channel.

Therefore, in the digital broadcast receiving apparatus 100, the tuner for last viewing can be used when the channel selection operation for returning to the original channel is performed. Since the tuner for last viewing has already tuned to the original channel, the demodulation circuit, the TS processor, and the MPEG decoder are operated without any re-tuning, which can shorten the required time for viewing.

Further, when the user performs a channel operation again subsequently to FIG. 3(c) in an attempt to change a channel for viewing to 25 channel, the destination channel is 25 channel, and therefore, the destination channel and the currently tuned channel match each other, and this time, the processing proceeds from block 2 to block 7. Therefore, since a program of 25 channel is viewed without any re-tuning by the digital tuner 121, the required time for viewing can be shortened and the program can be quickly viewed also in this case.

Thus, when programs of different channels are alternately viewed, the digital broadcast receiving apparatus 100 can shorten the required time for viewing and allows a user to view the program quickly.

### Second Embodiment

In the above-described first embodiment, when the destination channel does not match any of the currently tuned channels, the tuner not for last viewing different from the tuner for last viewing is used to tune to the destination channel.

The digital broadcast receiving apparatus 100 may tune to the destination channel by using either of the digital tuners 101, 121 which is selected based on a selection standard determined as follows. The following three first to third standard are possible selection standard.

The first selection standard is based on the magnitude of the number of selection times. Specifically, a tuner selected out of the digital tuners 101, 121 based on the first standard is the one tuning to a channel whose number of selection times is smaller (that is, a low-frequency channel less frequently selected and thus is not likely to be selected).

For example, the number of selection times of a channel tuned to by the digital tuner 101 and the number of selection times of a channel tuned to by the digital tuner 121 are compared, and the tuner tuning to the channel with a smaller number of selection times is selected.

The second selection standard is based on the length of the selection time. Specifically, a tuner selected out of the digital tuners 101, 121 based on the second selection standard is the one tuning to a channel with a shorter selection time (this is also a low-frequency channel which is less frequently selected).

For example, the selection time of a channel tuned to by the digital tuner 101 and the selection time of a channel tuned to by the digital tuner 121 are compared and the tuner tuning to the channel with a shorter selection time is selected.

The third selection standard is based on whether or not either of the tuners has tuned to a channel broadcasting a program belonging to a program type registered in advance. Here, the program type means each type in types (categories) to which various kinds of programs of the digital terrestrial broadcasting are classified.

In the digital broadcast receiving apparatus 100, a user can set a desired category as “a favorite category”. Then, the digital broadcast receiving apparatus 100 reads out the “favorite category” to compare categories to which programs on air on currently tuned channels by the digital tuners 101, 121 with the “favorite category”, and the tuner corresponding to mismatch determination is selected.

That is, the digital broadcast receiving apparatus 100 leaves the tuner tuning to a channel broadcasting a program often viewed by a user, as it is, and selects the other tuner.

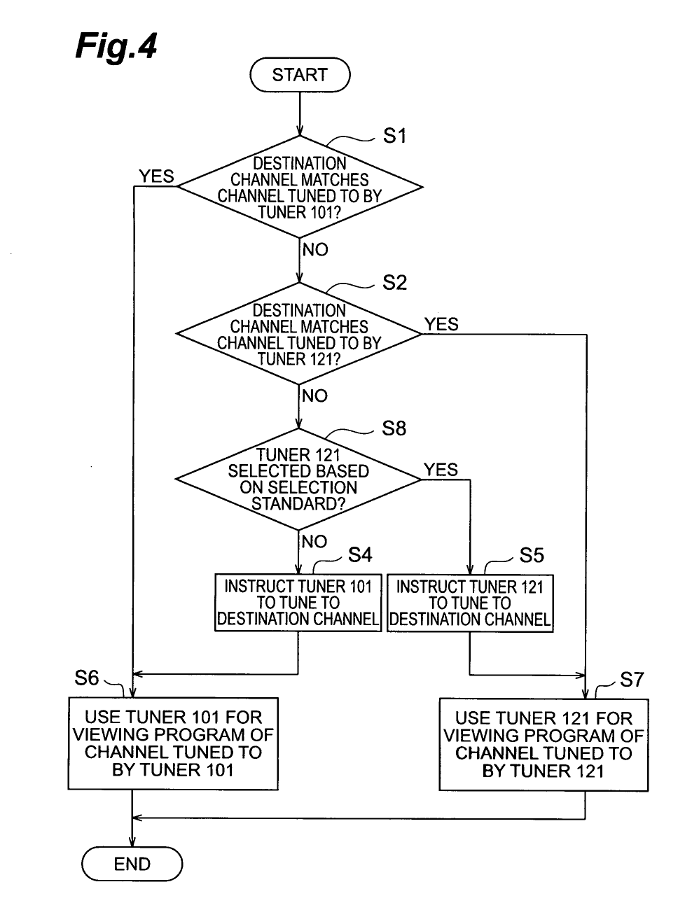

In a case where the digital broadcast receiving apparatus 100 executes the tuning processing according to the first to third selection standard, the tuning processing can be executed according to the flowchart shown in FIG. 4. This flowchart is different from the flowchart shown in FIG. 2 in that block 8 is executed instead of block 3.

At block 8, it is determined whether or not a tuner selected by the controller 131 based on the selection standard is the digital tuner 121, and if the selected tuner is the digital tuner 121, the controller 131 proceeds to block 5, and if not, proceeds to block 4.

The tuner is selected based on the selection standard set as described above, so that the tuning can be processed in a manner adapted to the actual situation of the tuning.

### Third Embodiment

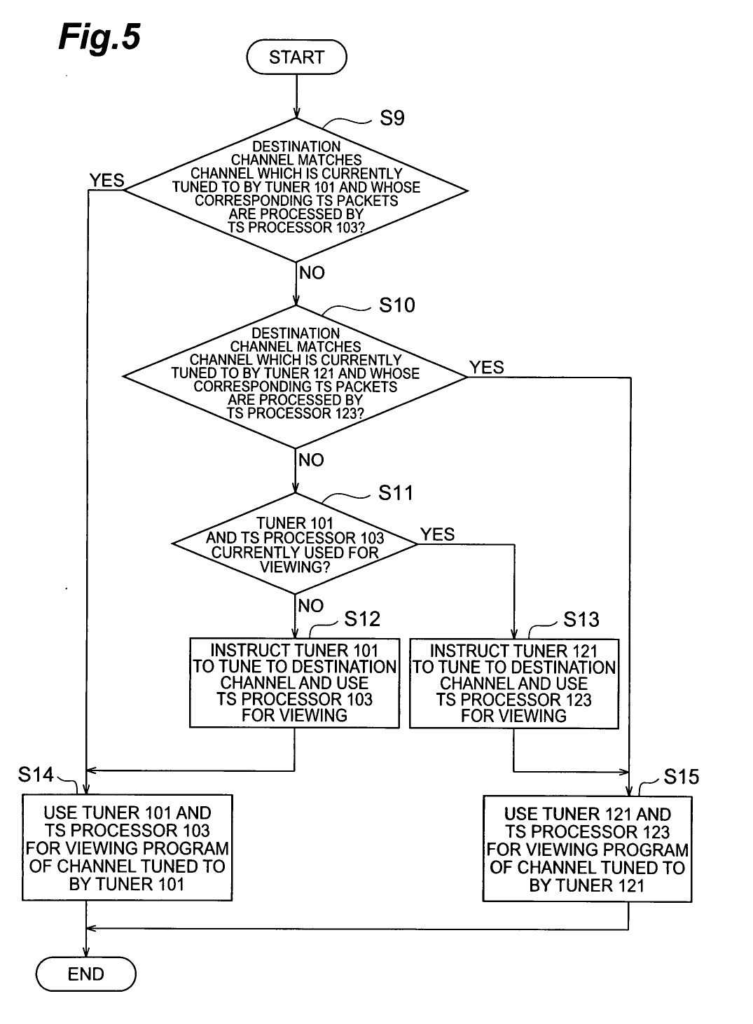

In the first embodiment and the second embodiment, the two digital tuners 101, 121 are appropriately used depending on the situation, and when the plural TS processors 103, 123 are provided in correspondence to the plural digital tuners 101, 121 as in the digital broadcast receiving apparatus 100, it is desirable to appropriately use the TS processors 103, 123 depending on the situation. In this case, the controller 131 executes the tuning processing according to the flowchart shown in FIG. 5.

When starting the tuning processing, the controller 131 proceeds to block 9, where the controller 131 compares a destination channel with a currently tuned channel which is tuned to by the digital tuner 101 and whose corresponding TS packets are processed by the TS processor 103 and determines whether or not the both match each other.

When determining that the both match each other, the controller 131 proceeds to block 14, and if not, proceeds to block 10.

At block 10, the controller 131 compares the destination channel with a currently tuned channel which is tuned to by the digital tuner 121 and whose corresponding TS packets are processed by the TS processor 123 and determines whether or not the both match each other.

When determining that the both match each other, the controller 131 proceeds to block 15, and if not, proceeds to block 11.

At block 11, the controller 131 determines whether or not the digital tuner 101 and the TS processor 103 are currently used for viewing, that is, whether or not the currently tuned channel by the digital tuner 101 is currently viewed and the TS processor 103 is processing the TS packets in response to the operation of the digital tuner 101. Then, the controller 131 proceeds to block 13 when the conditions are satisfied at block 11, while proceeding to block 12 when the conditions are not satisfied at block 11.

At block 12, the controller 131 performs control so that the digital tuner 101 tunes to the destination channel and the TS processor 103 processes TS packets, and thereafter proceeds to block 14. Consequently, in response to the instruction of the controller 131, the digital tuner 101 tunes to the destination channel, and the TS processor 103 processes the obtained TS packets.

Meanwhile, at block 13, the controller 131 performs control so that the digital tuner 121 tunes to the destination channel and the TS processor 123 processes the TS packets, and thereafter proceeds to block 15. Consequently, in response to the instruction of the controller 131, the digital tuner 121 tunes to the destination channel, and the TS processor 123 processes the obtained TS packets.

Then, at block 14, the controller 131 performs control so as to make a program of the channel tuned to by the digital tuner 101 viewable, by using the digital tuner 101 and the TS processor 103. In this case, the digital tuner 101 is a currently tuning tuner and the TS processor 103 is a currently processing TS processor.

Consequently, the monitor 134 displays video and the speaker 136 outputs sound based on a digital video signal and a digital sound signal which are obtained as a result of the operation of the digital tuner 101, the modulation circuit 102, the TS processor 103, and the MPEG decoder 104, so that the program of the currently tuned channel is viewed.

Meanwhile, at block 15, the controller 131 performs control so as to make the program of the channel tuned to by the digital tuner 121 viewable, by using the digital tuner 121 and the TS processor 123. In this case, the digital tuner 121 is a currently tuning tuner and the TS processor 123 is a currently processing TS processor.

Consequently, the monitor 134 displays video and the speaker 136 outputs sound based on a digital video signal and a digital sound signal obtained as a result of the operation of the digital tuner 121, the demodulation circuit 122, the TS processor 123, and the MPEG decoder 124, so that the program of the currently tuned channel is viewed.

Also in such execution of the tuning processing, in the digital broadcast receiving apparatus 100, a tuner for last viewing is left as it is and a tuner not for last viewing is used to tune to the destination channel when the destination channel does not match any of the currently tuned channels, similarly to the first embodiment. Therefore, in the digital broadcast receiving apparatus 100, the tuner for last viewing can be used when a channel selection operation for returning to the original channel again is performed, which can shorten the required time for viewing.

Moreover, in the tuning processing executed as in the third embodiment, the same applies to the TS processors when the destination channel does not match any of the currently tuned channels, that is, the TS processor for last viewing is left as it is, and the other processor not for current viewing is used. Consequently, the time required for switching in the TS processor is shortened, which brings about an effect of further shortening the required time for viewing.

The above-described embodiments describe, as an example, the digital broadcast receiving apparatus in which the plural TS processors 103, 123 are provided in correspondence to the plural digital tuners 101, 121 and the digital processors 101, 121 operate in response to the digital tuners 101, 121.

The invention is also applicable to a digital broadcast receiving apparatus including a TS processor operating commonly in response to both of the plural digital tuners 101, 121. In this case, the tuning processing may be executed according to the flow in the first embodiment or the second embodiment.

Further, the above-described embodiments describe, as an example, the digital broadcast receiving apparatus 100 receiving digital terrestrial broadcasts, but the invention is also applicable to a digital broadcast receiving apparatus receiving digital satellite broadcasts.

The foregoing description is description of the embodiments of the invention, and is not intended to limit the device and method of the invention, and various modified examples can be easily implemented. Further, a device or a method structured by appropriate combination of the constituent elements, functions, features, or method blocks in the embodiments are also included in the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A digital broadcast receiving apparatus comprising a plurality of tuners selecting broadcast waves of digital broadcasting to receive frequencies in a same band, the apparatus comprising
a control unit which performs control in which, when a first channel currently viewed with the use of a first tuner out of said plural tuners is changed to a second channel to be viewed with the use of a second tuner out of said plural tuners and subsequently a channel operation takes place for changing the second channel to the first channel, said first tuner having tuned to the first channel is used for viewing a program of the first channel.

2. The digital broadcast receiving apparatus according to claim 1, further comprising a tuning control unit performing tuning control in which, when a designation channel designated by a channel selection instruction matches a currently tuned channel tuned to by one of said tuners, said currently tuning tuner tuning to the currently tuned channel is used for viewing a program of the currently tuned channel, and when the destination channel does not match any of the currently tuned channels, a tuner not for last viewing different from a tuner for last viewing used for viewing at the time of the channel selection instruction is used to tune to the destination channel.

3. The digital broadcast receiving apparatus according to claim 2, further comprising a determining unit determining whether or not the destination channel matches the currently tuned channel tuned to by each of said tuners, and
wherein said tuning control unit performs the tuning control based on results of the determination by said determining unit.

4. The digital broadcast receiving apparatus according to claim 1, further comprising a tuning control unit performing tuning control in which, when a destination channel designated by a channel selection instruction matches a currently tuned channel tuned to by one of said tuners, said currently tuning tuner tuning to the currently tuned channel is used for viewing a program of the currently tuned channel, and when the destination channel does not match any of the currently tuned channels, a tuner selected from said tuners based on a selection standard for selecting one of said plural tuners is used to tune to the destination channel.

5. The digital broadcast receiving apparatus according to claim 4, wherein the selection standard is set so as to select a low-frequency tuner that has tuned to a low-frequency channel less frequently selected, out of the channels.

6. The digital broadcast receiving apparatus according to claim 5, wherein the selection standard is set so as to define, as the low-frequency channel, a channel whose number of selection times is smaller or whose selection time is shorter, out of the channels.

7. The digital broadcast receiving apparatus according to claim 4, wherein the selection standard is set so as to select, from said plural tuners, a tuner different from a tuner tuning to a channel broadcasting a program belonging to a program type registered in advance.

8. The digital broadcast receiving apparatus according to claim 1, further comprising a display panel displaying video showing a content of a program currently viewed.

9. A digital broadcast receiving apparatus comprising: a plurality of tuners selecting and receiving broadcast waves of digital broadcasting; and a plurality of TS processors provided in correspondence to said tuners, the apparatus comprising
a tuning control unit performing tuning control in which:
when a destination channel designated by a channel selection instruction matches a currently tuned channel which is tuned to by one of said tuners and whose corresponding TS packet is processed by one of said TS processors, said currently tuning tuner tuning to the currently tuned channel and said currently processing TS processor processing the TS packet are used for viewing a program of the currently tuned channel; and
when the destination channel does not match any of the currently tuned channels, a tuner not for last viewing different from a tuner for last viewing used for viewing at the time of the channel selection instruction out of said plural tuners is used to tune to the destination channel, and a TS processor not for last viewing different from a TS processor for last viewing processing the TS packet in response to said tuner for last viewing is used to process a TS packet.

10. A digital broadcast receiving method using a plurality of tuners each selecting and receiving a broadcast wave of digital broadcasting, the method comprising performing control in which, when a first channel currently viewed is changed to a second channel to be viewed and subsequently a channel operation takes place for changing the second channel back to the first channel, a tuner having originally tuned to the first channel, out of the plural tuners, is used for viewing a program of the first channel.
